(19) United States
(12) Patent Application Publication
(10) Pub. No.: US 2014/0146582 A1
(43) Pub. Date: May 29, 2014

(54) HIGH VOLTAGE DIRECT CURRENT (HVDC) CONVERTER SYSTEM AND METHOD OF OPERATING THE SAME

(71) Applicant: GENERAL ELECTRIC COMPANY, Schenectady, NY (US)

(72) Inventors: Ranjan Kumar Gupta, Schenectady, NY (US); Nilanjan Ray Chaudhuri, Niskayuna, NY (US)

(73) Assignee: General Electric Company, Schenectady, NY (US)

(21) Appl. No.: 13/688,658

(22) Filed: Nov. 29, 2012

(51) Int. Cl. H02J 3/36

(52) U.S. Cl. CPC H02J 3/36
USPC 363/35

(57) ABSTRACT

A high voltage direct current (HVDC) converter system includes at least one line commutated converter (LCC) and at least one current controlled converter (CCC). The at least one LCC and the at least one CCC are coupled in parallel to at least one alternating current (AC) conduit and are coupled in series to at least one direct current (DC) conduit. The at least one LCC is configured to convert a plurality of AC voltages and currents to a regulated DC voltage of one of positive and negative polarity and a DC current transmitted in only one direction. The at least one current controlled converter (CCC) is configured to convert a plurality of AC voltages and currents to a regulated DC voltage of one of positive and negative polarity and a DC current transmitted in one of two directions.

### STATEMENT REGARDING FEDERALLY SPONSORED RESEARCH & DEVELOPMENT

This invention was made with Government support under contract number DE-AR0000224 awarded by the Advanced Research Projects Agency-Energy (ARPA-E). The Government may have certain rights in this invention.

### BACKGROUND

The field of the invention relates generally to high voltage direct current (HVDC) transmission systems and, more particularly, to HVDC converter systems and a method of operation thereof.

At least some of known electric power generation facilities are physically positioned in a remote geographical region or in an area where physical access is difficult. One example includes power generation facilities geographically located in rugged and/or remote terrain, for example, mountainous hillsides, extended distances from the customers, and off-shore, e.g., off-shore wind turbine installations. More specifically, these wind turbines may be physically nested together in a common geographical region to form a wind turbine farm and are electrically coupled to a common alternating current (AC) collector system. Many of these known wind turbine farms include a separated power conversion assembly, or system, electrically coupled to the AC collector system. Such known separated power conversion assemblies include a rectifier portion that converts the AC generated by the power generation facilities to direct current (DC) and an inverter that converts the DC to AC of a predetermined frequency and voltage amplitude. The rectifier portion of the separated power conversion assembly is positioned in close vicinity of the associated power generation facilities and the inverter portion of the separated full power conversion assembly is positioned in a remote facility, such as a land-based facility. Such rectifier and inverter portions are typically electrically connected via submerged high voltage direct current (HVDC) electric power cables that at least partially define an HVDC transmission system.

Many known power converter systems include rectifiers that include line commutated converters (LCCs). LCC-based rectifiers typically use thyristors for commutation to “chop” three-phase AC voltage through firing angle control to generate a variable DC output voltage. Commutation of the thyristors requires a stiff, i.e., substantially nonvarying, grid voltage. Therefore, for those regions without a stiff AC grid, converters with such rectifiers cannot be used. Also, a “black start” using such a HVDC transmission system is not possible. Further, such known thyristor-based rectifiers require significant reactive power transmission from the AC grid to the thyristors, with some reactive power requirements representing approximately 50% to 60% of the rated power of the rectifier. Moreover, thyristor-based rectifiers facilitate significant transmission of harmonic currents from the AC grid, e.g., the 11^{th} and 13^{th} harmonics, such harmonic currents typically approximately 10% of the present current loading for each of the 11^{th} and 13^{th} harmonics. Therefore, to compensate for the harmonic currents and reactive power, large AC filters are installed in the associated AC switchyard. In some known switchyards, the size of the AC filter portion is at least 3 times greater than the size of the associated thyristor-based rectifier portion. Such AC filter portion of the switchyard is capital—intensive due to the land required and the amount of large equipment installed. In addition, a significant investment in replacement parts and preventative and corrective maintenance activities increases operational costs.

In addition, many known thyristors in the rectifiers switch only once per line cycle. Therefore, such thyristor-based rectifiers exhibit operational dynamic features that are less than optimal for generating smoothed waveforms. Also, typically, known thyristor-based LCCs are coupled to a transformer and such transformer is constructed with heightened ratings to accommodate the reactive power and harmonic current transmission through the associated LCC. Moreover, for those conditions that include a transient, or fault, on either of the AC side and the DC side of the thyristor-based rectifier, interruption of proper commutation may result.

### BRIEF DESCRIPTION

In one aspect, a high voltage direct current (HVDC) converter system is provided. A high voltage direct current (HVDC) converter system includes at least one line commutated converter (LCC) and at least one current controlled converter (CCC). The at least one LCC and the at least one CCC are coupled in parallel to at least one alternating current (AC) conduit and are coupled in series to at least one direct current (DC) conduit. The at least one LCC is configured to convert a plurality of AC voltages and currents to a regulated DC voltage of one of positive and negative polarity and a DC current transmitted in only one direction. The at least one current controlled converter (CCC) is configured to convert a plurality of AC voltages and currents to a regulated DC voltage of one of positive and negative polarity and a DC current transmitted in one of two directions.

In a further aspect, a method of transmitting high voltage direct current (HVDC) electric power is provided. The method includes providing at least one line commutated converter (LCC) configured to convert a plurality of alternating current (AC) voltages and currents to a regulated direct current (DC) voltage of one of positive and negative polarity and a DC current transmitted in only one direction. The method also includes providing at least one current controlled converter (CCC) configured to convert a plurality of AC voltages and currents to a regulated DC voltage of one of positive and negative polarity and a DC current transmitted in one of two directions. The at least one LCC and the at least one CCC are coupled in parallel to at least one AC conduit and are coupled in series to at least one DC conduit. The method further includes transmitting at least one of AC current and DC current to the at least one LCC and the at least one CCC. The method also includes defining a predetermined voltage differential across a HVDC transmission system with the at least one LCC. The method further includes controlling a value of current transmitted through the HVDC transmission system with the at least one CCC.

In another aspect, a high voltage direct current (HVDC) transmission system is provided. The HVDC transmission system includes at least one alternating current (AC) conduit and at least one direct current (DC) conduit. The system also includes a plurality of HVDC transmission conduits coupled to the at least one DC conduit. The system further includes a HVDC converter system. The HVDC converter system includes at least one line commutated converter (LCC) configured to convert a plurality of AC voltages and currents to a regulated DC voltage of one of positive and negative polarity and a DC current transmitted in only one direction. The HVDC converter system also includes at least one current controlled converter (CCC) configured to convert a plurality of AC voltages and currents to a regulated DC voltage of one of positive and negative polarity and a DC current transmitted in one of two directions. The at least one LCC and the at least one CCC are coupled in parallel to the at least one AC conduit and are coupled in series to the at least one DC conduit.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic view of an exemplary high voltage direct current (HVDC) transmission system;

FIG. 2 is a schematic view of an exemplary rectifier portion that may be used with the HVDC transmission system shown in FIG. 1;

FIG. 3 is a schematic view of an exemplary HVDC rectifier device that may be used with the rectifier portion shown in FIG. 2;

FIG. 4 is a schematic view of an exemplary HVDC current controlled converter (CCC) that may be used with the rectifier portion shown in FIG. 2;

FIG. 5 is a schematic view of an exemplary inverter portion that may be used with the HVDC transmission system shown in FIG. 1;

FIG. 6 is a schematic view of an exemplary HVDC inverter device that may be used with the inverter portion shown in FIG. 5;

FIG. 7 is a schematic view of an exemplary black start configuration that may be used with the HVDC transmission system shown in FIG. 1;

FIG. 8 is a schematic view of an exemplary alternative embodiment of the HVDC transmission system shown in FIG. 1; and

FIG. 9 is a schematic view of another exemplary alternative embodiment of the HVDC transmission system shown in FIG. 1.

Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for the practice of the invention.

### DETAILED DESCRIPTION

In the following specification and the claims, reference will be made to a number of terms, which shall be defined to have the following meanings

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “black start” refers to providing electric power to at least one power generation facility in a geographically-isolated location from a source external to the power generation facility. A black start condition is considered to exist when there are no electric power generators in service in the power generation facility and there are no other sources of electric power in the geographically-isolated power generation facility to facilitate a restart of at least one electric power generator therein.

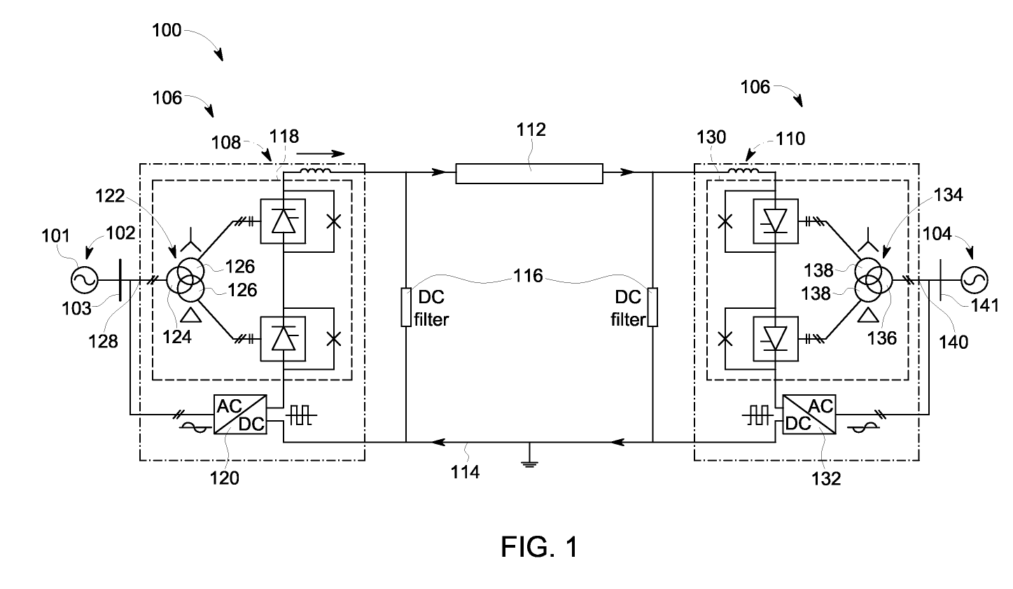

FIG. 1 is a schematic view of an exemplary high voltage direct current (HVDC) transmission system 100. HVDC transmission system 100 couples an alternating current (AC) electric power generation facility 102 to an electric power transmission and distribution grid 104. Electric power generation facility 102 may include one power generation device 101, for example, one wind turbine generator. Alternatively, electric power generation facility 102 may include a plurality of wind turbine generators (none shown) that may be at least partially grouped geographically and/or electrically to define a renewable energy generation facility, i.e., a wind turbine farm (not shown). Such a wind turbine farm may be defined by a number of wind turbine generators in a particular geographic area, or alternatively, defined by the electrical connectivity of each wind turbine generator to a common substation. Also, such a wind turbine farm may be physically positioned in a remote geographical region or in an area where physical access is difficult. For example, and without limitation, such a wind turbine farm may be geographically located in rugged and/or remote terrain, e.g., mountainous hillsides, extended distances from the customers, and off-shore, e.g., off-shore wind turbine installations. Further, alternatively, electric power generation facility 102 may include any type of electric generation system including, for example, solar power generation systems, fuel cells, thermal power generators, geothermal generators, hydropower generators, diesel generators, gasoline generators, and/or any other device that generates power from renewable and/or non-renewable energy sources. Power generation devices 101 are coupled at an AC collector 103.

HVDC transmission system 100 includes a separated power conversion system 106. Separated power conversion system 106 includes a rectifier portion 108 that is electrically coupled to electric power generation facility 102. Rectifier portion 108 receives three-phase, sinusoidal, alternating current (AC) power from electric power generation facility 102 and rectifies the three-phase, sinusoidal, AC power to direct current (DC) power at a predetermined voltage.

Separated power conversion system 106 also includes an inverter portion 110 that is electrically coupled to electric power transmission and distribution grid 104. Inverter portion 110 receives DC power transmitted from rectifier portion 108 and converts the DC power to three-phase, sinusoidal, AC power with pre-determined voltages, currents, and frequencies. In the exemplary embodiment, and as discussed further below, rectifier portion 108 and inverter portion 110 are substantially similar, and depending on the mode of control, they are operationally interchangeable.

Rectifier portion 108 and inverter portion 110 are coupled electrically through a plurality of HVDC transmission conduits 112 and 114. In the exemplary embodiment, HVDC transmission system 100 includes a uni-polar configuration and conduit 112 is maintained at a positive voltage potential and conduit 114 is maintained at a substantially neutral, or ground potential. Alternatively, HVDC transmission system 100 may have a bi-polar configuration, as discussed further below. HVDC transmission system 100 also includes a plurality of DC filters 116 coupled between conduits 112 and 114.

HVDC transmission conduits 112 and 114 include any number and configuration of conductors, e.g., without limitation, cables, ductwork, and busses that are manufactured of any materials that enable operation of HVDC transmission system 100 as described herein. In at least some embodiments, portions of HVDC transmission conduits 112 and 114 are at least partially submerged. Alternatively, portions of HVDC transmission conduits 112 and 114 extend through geographically rugged and/or remote terrain, for example, mountainous hillsides. Further, alternatively, portions of HVDC transmission conduits 112 and 114 extend through distances that may include hundreds of kilometers (miles).

In the exemplary embodiment, rectifier portion 108 includes a rectifier line commutated converter (LCC) 118 coupled to HVDC transmission conduit 112. Rectifier portion 108 also includes a rectifier current controlled converter (CCC) 120 coupled to rectifier LCC 118 and HVDC transmission conduit 114. CCC 120 is configured to generate either a positive or negative output voltage. Rectifier portion 108 further includes a rectifier LCC transformer 122 that either steps up or steps down the voltage received from electric power generation facility 102. Transformer 122 includes one set of primary windings 124 and two substantially similar sets of secondary windings 126. First transformer 118 is coupled to electric power generation facility 102 through a plurality of first AC conduits 128 (only one shown).

Similarly, in the exemplary embodiment, inverter portion 110 also includes an inverter LCC 130 coupled to HVDC transmission conduit 112. Inverter portion 110 also includes an inverter CCC 132 coupled to inverter LCC 130 and HVDC transmission conduit 114. Inverter LLC 130 is substantially similar to rectifier LCC 118 and inverter CCC 132 is substantially similar to rectifier CCC 120.

Inverter portion 110 further includes an inverter LCC transformer 134 that either steps down or steps up the voltage transmitted to grid 104. Transformer 134 includes one set of primary windings 136 and two substantially similar sets of secondary windings 138. Inverter LCC transformer 134 is coupled to grid 104 through a plurality of second AC conduits 140 (only one shown) and an AC collector 141. In the exemplary embodiment, transformers 122 and 134 have a wye-delta configuration. Inverter LCC transformer 134 is substantially similar to rectifier LCC transformer 122. Alternatively, rectifier LCC transformer 122 and inverter LCC transformer 134 are any type of transformers with any configuration that enable operation of HVDC transmission system 100 as described herein.

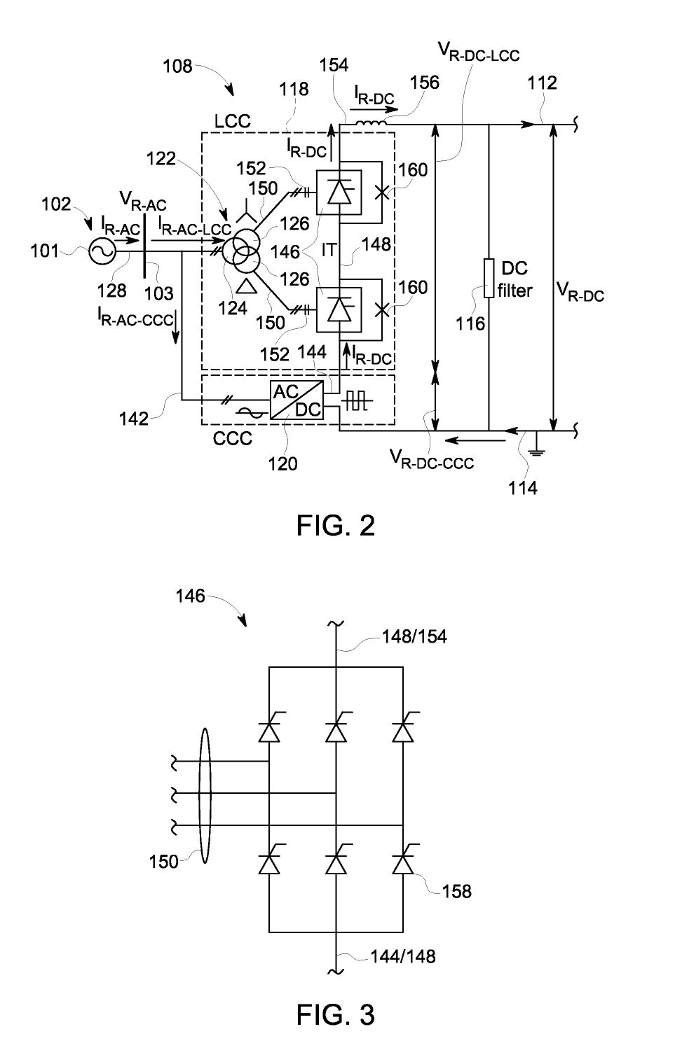

FIG. 2 is a schematic view of rectifier portion 108 of HVDC transmission system 100 (shown in FIG. 1). In the exemplary embodiment, primary windings 124 are coupled to electric power generation facility 102 through first AC conduits 128. Rectifier CCC 120 is coupled to first AC conduits 128 between electric power generation facility 102 and primary windings 124 through a rectifier CCC conduit 142. Therefore, rectifier CCC 120 and rectifier LCC 118 are coupled in parallel with electric power generation facility 102. Moreover, rectifier CCC 120 and rectifier LCC 118 are coupled in series with each other through a DC conduit 144.

Also, in the exemplary embodiment, rectifier LCC 118 includes a plurality of HVDC rectifier devices 146 (only two shown) coupled to each other in series through a DC conduit 148. Each of HVDC rectifier devices 146 is coupled in parallel to one of secondary windings 126 through a plurality of AC conduit 150 (only one shown in FIG. 2) and a series capacitive device 152. At least one HVDC rectifier device 146 is coupled to HVDC transmission conduit 112 through an HVDC conduit 154 and an inductive device 156. Also, at least one HVDC rectifier device 146 is coupled in series to rectifier CCC 120 through DC conduit 144.

FIG. 3 is a schematic view of an exemplary HVDC rectifier device 146 that may be used with rectifier portion 108 (shown in FIG. 2), and more specifically, with rectifier LCC 118 (shown in FIG. 2). In the exemplary embodiment, HVDC rectifier device 146 is a thyristor-based device that includes a plurality of thyristors 158. Alternatively, HVDC rectifier device 146 uses any semiconductor devices that enable operation of rectifier LCC 118, rectifier portion 108, and HVDC transmission system 100 (shown in FIG. 1) as described herein, including, without limitation insulated gate commutated thyristors (IGCTs) and insulated gate bipolar transistors (IGBTs).

Referring again to FIG. 2, rectifier CCC 120 and rectifier LCC 118 are coupled in a cascading series configuration between HVDC transmission conduits 112 and 114. Moreover, a voltage of V_{R-DC-LCC} is induced across rectifier LCC 118, a voltage of V_{R-DC-CCC} is induced across rectifier CCC 120, and V_{R-DC-LCC} and V_{R-DC-CCC} are summed to define V_{R-DC}, i.e., the total DC voltage induced between HVDC transmission conduits 112 and 114 by rectifier portion 108. Furthermore, an electric current of I_{R-AC-LCC} is drawn through rectifier LCC 118, an electric current of I_{R-AC-CCC} is drawn through rectifier CCC 120, and I_{R-AC-LCC} and I_{R-AC-CCC} are summed to define the net electric current (AC) drawn from electric power generation facility 102, i.e., I_{R-AC}. First AC conduits 128 are operated at an AC voltage of V_{R-AC} as induced by electric power generation facility 102.

Further, in the exemplary embodiment, rectifier LCC 118 is configured to convert and transmit active AC power within a range between approximately 85% and approximately 100% of a total active AC power rating of HVDC transmission system 100. LCC 118 converts a plurality of AC voltages, i.e., V_{R-AC}, and currents, i.e., I_{R-AC-LCC}, to a regulated DC voltage, i.e., V_{R-DC-LCC}, of one of either a positive polarity or a negative polarity, and a DC current transmitted in only one direction.

Moreover, in the exemplary embodiment, rectifier CCC 120 is configured to convert and transmit active AC power within a range between approximately 0% and approximately 15% of the total active AC power rating of HVDC transmission system 100. CCC 120 converts a plurality of AC voltages, i.e., V_{R-AC} and currents, i.e., I_{R-AC-LCC}, to a regulated DC voltage, i.e., V_{R-DC-CCC}, of one of either a positive polarity and a negative polarity, and a DC current transmitted in one of two directions.

Both rectifier LCC 118 and rectifier CCC 120 are both individually configured to generate and transmit all of a net electric current (DC) generated by rectifier portion 108, i.e., rated I_{R-DC}. Also, rectifier CCC 120 is configured to control its output DC voltage, positive or negative based on the direction of power flow, up to approximately 15% of V_{R-DC} to facilitate control of I_{R-DC}. Further, rectifier CCC 120 facilitates active filtering of AC current harmonics, e.g., 11^{th} and 13^{th} harmonics, and up to approximately 10% of the reactive power rating of rectifier portion 108 for the electric power transmitted from power generation facility 102.

Moreover, in the exemplary embodiment, thyristors 158 (shown in FIG. 3) of HVDC rectifier device 146 are configured to operate with firing angles α of ≦5°. As used herein, the term “firing angle” refers to an angular difference in degrees along a 360° sinusoidal waveform between the point of the natural firing instant of thyristors 158 and the point at which thyristors 158 are actually triggered into conduction, i.e., the commutation angle. The associated firing lag facilitates an associated lag between the electric current transmitted through thyristor 158 and the voltage induced by thyristor 158. Therefore, HVDC rectifier device 146, and as a consequence, rectifier portion 108 and separated power conversion system 106 (both shown in FIG. 1) are net consumers of reactive power. The amount of reactive power consumed is a function of firing angle α, i.e., as firing angle α increases, the reactive power consumed increases. In addition, the magnitude of the induced voltage is also a function of firing angle α, i.e., as firing angle α increases, the magnitude of the induced voltage decreases.

Therefore, in the exemplary embodiment, V_{R-DC-LCC} represents a much greater percentage of V_{R-DC} than does V_{R-DC-CCC}, i.e., approximately 85% or higher as compared to approximately 15% or lower, respectively, and subsequently, the reactive power consumption of rectifier LCC 118 is reduced to a substantially low value, i.e., less than 20% of the power rating of rectifier LCC 118. In addition, rectifier LCC 118 is configured to quickly decrease V_{R-DC} in the event of a DC fault or DC transient.

Moreover, in the exemplary embodiment, rectifier LCC 118 is configured to establish the transmission voltage such that V_{R-DC-LCC} is approximately equal to a V_{I-DC-LCC} (not shown in FIG. 2, and discussed further below) at inverter LCC 130 (shown in FIG. 1). In some embodiments, rectifier LCC transformer 122 has a turns ratio value of primary windings 124 to secondary windings 126 such that V_{R-DC-LCC} is substantially equal to the V_{I-DC} value (not shown in FIG. 2, and discussed further below) induced at HVDC inverter portion 110. Furthermore, rectifier CCC 120 is configured to regulate V_{R-DC-CCC} such that rectifier CCC 120 effectively regulates I_{R-DC} through substantially an entire range of operational values of current transmission though HVDC transmission system 100. As such, electric power orders, i.e., electric dispatch commands may be implemented through a control system (not shown) coupled to rectifier CCC 120.

Also, in the exemplary embodiment, each series capacitive device 152 facilitates a decrease in the predetermined reactive power rating of rectifier CCC 120 by facilitating an even lower value of firing angle α, including a negative value if desired, for rectifier LCC 118. The overall power rating for rectifier CCC 120 is reduced which facilitates decreasing the size and costs of rectifier portion 108. Further, the accumulated electric charges in each series capacitive device 152 facilitates commutation ride-through, i.e., a decreases in the potential of short-term commutation failure in the event of short-term AC-side and/or DC-side electrical transients. Therefore, rectifier LCC 118 facilitates regulation of firing angle α.

Rectifier LCC 118 also includes a switch device 160 that is coupled in parallel with each associated HVDC rectifier device 146. In the exemplary embodiment, switch device 160 is manually and locally operated to close to bypass the associated HVDC rectifier device 146. Alternatively, switch device 160 may be operated remotely.

Moreover, a plurality of auxiliary loads (not shown) for electric power generation facility 102 are powered from first AC conduits 128 and/or AC collector 103. Such auxiliary loads may include wind turbine support equipment including, without limitation, blade pitch drive motors, shaft bearing lubrication drive motors, solar array sun-following drive motors, and turbine lube oil pumps (none shown). Therefore, these auxiliary loads are typically powered with a portion of electric power generated by at least one of electric power generators 101 through first AC conduits 128 and/or AC collector 103.

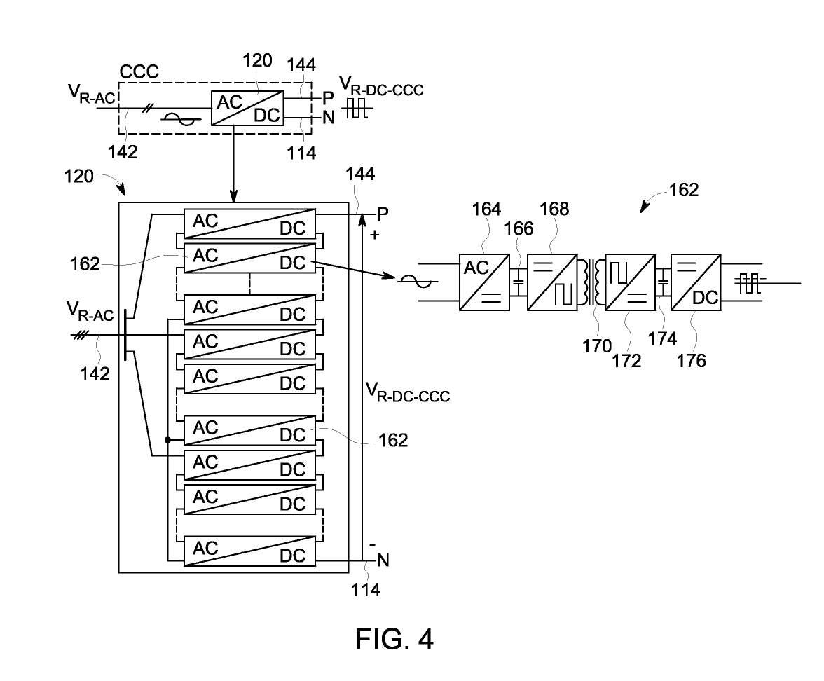

FIG. 4 is a schematic view of exemplary HVDC current controlled converter (CCC) 120 that may be used with rectifier portion 108 (shown in FIG. 2). Rectifier CCC 120 includes a plurality of cascaded AC/DC cells 162. AC/DC cells 162 include any semiconductor devices that enable operation of CCC 120 as described herein, including, without limitation, silicon controlled rectifiers (SCRs), gate commutated thyristors (GCTs), symmetrical gate commutated thyristors (SGCTs), and gate turnoff thyristors (GTOs).

AC/DC cells are arranged and cascaded to enable operation of rectifier CCC 120, rectifier portion 108, and HVDC transmission system 100 (shown in FIG. 1) as described herein. Each AC/DC cell 162 includes a first AC-to-DC rectifier portion 164, a first DC link 166, a DC-to-AC inverter 168, a linking transformer 170, a second AC-to-DC rectifier portion 172, a second DC link 174, and a DC-DC voltage regulator 176, all coupled in series. In the exemplary embodiment, DC-DC voltage regulator 176 is a soft-switching converter that operates at a fixed frequency and duty cycle in a manner similar to a DC-to-DC transformer. Alternatively, DC-DC voltage regulator 176 is any device that enables operation of rectifier CCC 120 as described herein. Each AC/DC cell 162 receives a portion of V_{R-AC} induced on rectifier CCC conduit 142. The cascaded, and interleaved, configuration of AC/DC cells 162 facilitates lower AC voltages at first AC-to-DC rectifier portion 164 such that finer control of V_{R-CCC} is also facilitated. In some embodiments, depending on the value of V_{R-AC}, rectifier CCC 120 may contain a step-down transformer (not shown) at rectifier CCC conduit 142 to facilitate reducing the voltage rating of AC/DC cells 162. Also, in some embodiments, depending on the value of V_{R-AC}, rectifier CCC 120 may contain a step-up transformer (not shown) at rectifier CCC conduit 142 to facilitate increasing the voltage rating of AC/DC cells 162.

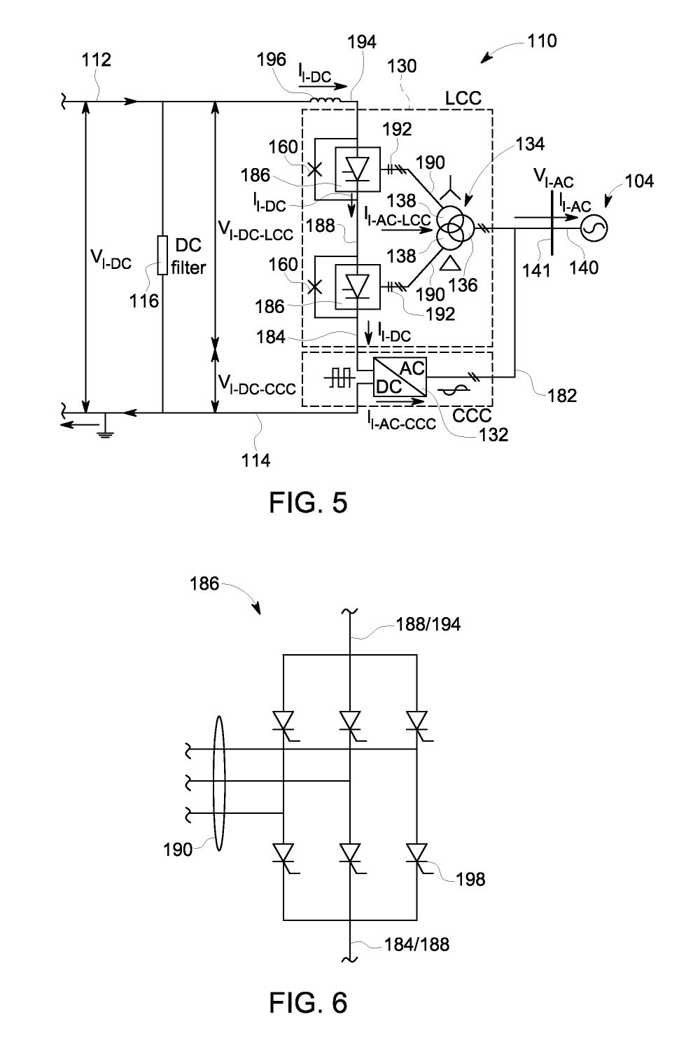

FIG. 5 is a schematic view of exemplary inverter portion 110 that may be used with the HVDC transmission system 100 (shown in FIG. 1). In general, rectifier portion 108 and inverter portion 110 have substantially similar circuit architectures. In the exemplary embodiment, primary windings 136 are coupled to electric power transmission and distribution grid 104 through second AC conduits 140. inverter CCC 132 is coupled to second AC conduits 140 between grid 104 and primary windings 136 through an inverter CCC conduit 182. Therefore, inverter CCC 132 and inverter LCC 130 are coupled in parallel with grid 104. Moreover, inverter CCC 132 and inverter LCC 130 are coupled in series with each other through a DC conduit 184.

Also, in the exemplary embodiment, inverter LCC 130 includes a plurality of HVDC inverter devices 186 (only two shown) coupled to each other in series through a DC conduit 188. HVDC inverter devices 186 are substantially similar to HVDC rectifier devices 146 (shown in FIG. 2). Each of HVDC inverter devices 186 is coupled in parallel to one of secondary windings 136 through a plurality of AC conduit 190 (only one shown in FIG. 5) and a series capacitive device 192. At least one HVDC inverter device 186 is coupled to HVDC transmission conduit 112 through an HVDC conduit 194 and an inductive device 196. Also, at least one HVDC inverter device 196 is coupled in series to inverter CCC 132 through DC conduit 184.

FIG. 6 is a schematic view of an exemplary HVDC inverter device 186 that may be used with inverter portion 110 (shown in FIG. 5), and more specifically, with inverter LCC 130 (shown in FIG. 5). In the exemplary embodiment, HVDC inverter device 186 is a thyristor-based device that includes a plurality of thyristors 198 that are substantially similar to thyristors 158 (shown in FIG. 3). Alternatively, HVDC inverter device 186 uses any semiconductor devices that enable operation of inverter LCC 130, inverter portion 110, and HVDC transmission system 100 (shown in FIG. 1) as described herein, including, without limitation insulated gate commutated thyristors (IGCTs) and insulated gate bipolar transistors (IGBTs). In a manner similar to rectifier LCC 118 facilitating regulation of firing angle α for thyristors 158, inverter LCC 130 facilitates constant extinction angle control.

Referring again to FIG. 5, inverter CCC 132 and inverter LCC 130 are coupled in a cascading series configuration between HVDC transmission conduits 112 and 114. Moreover, a voltage of V_{I-DC-LCC} is induced across inverter LCC 130, a voltage of V_{I-DC-CCC} is induced across inverter CCC 132, and V_{I-DC-LCC} and V_{I-DC-CCC} are summed to define V_{I-DC}, i.e., the total DC voltage induced between HVDC transmission conduits 112 and 114 by inverter portion 110. Furthermore, an electric current of I_{I-AC-LCC} is generated by inverter LCC 130, an electric current of I_{R-AC-CCC} is generated by inverter CCC 132, and I_{I-AC-LCC} and I_{I-AC-CCC} are summed to define the net electric current (AC) transmitted to grid 104, i.e., I_{I-AC}. Second AC conduits 140 are operated at an AC voltage of V_{I-AC} as induced by grid 104.

Further, in the exemplary embodiment, inverter LCC 130 is configured to convert and transmit active power within a range between approximately 85% and approximately 100% of a total active power rating of HVDC transmission system 100. Moreover, inverter CCC 132 is configured to convert and transmit active power within a range between approximately 0% and approximately 15% of the total active power rating of HVDC transmission system 100.

Inverter LCC 130 also includes a switch device 160 that is coupled in parallel with each associated HVDC inverter device 186. In the exemplary embodiment, switch device 160 is manually and locally operated to close to bypass the associated HVDC inverter device 186. Alternatively, switch device 160 may be operated remotely.

In the exemplary embodiment, inverter CCC 132 supplies reactive power to grid 104, i.e., approximately 10% of the reactive power rating of inverter portion 110, to control a grid power factor to unity or other values. In addition, inverter CCC 132 cooperates with rectifier CCC 120 (shown in FIGS. 1 and 2) to substantially control transmission of harmonic currents to grid 104. Specifically, those significant, i.e., dominant harmonic currents, e.g., 11^{th} and 13^{th} harmonics, that can have current values as high as approximately 10% of rated current, are significantly reduced while maintaining total harmonic distortion (THD) in the grid current, i.e., I_{I-AC} as transmitted to grid 104, below the maximum THD per grid standards. Therefore, CCCs 120 and 132 substantially obviate a need for large filtering devices and facilities. However, alternatively, some filtering may be required and filters (not shown in FIGS. 2 and 5) may be installed at associated AC collectors 103 and 141, respectively, to mitigate residual high frequency harmonic currents uncompensated for by CCCs 120 and 132 to meet telephonic interference specifications and/or systems specifications in general.

Referring to FIGS. 1 through 6, during normal power generation operation, electric power generation facility 102 generates electric power through generators 101 that includes sinusoidal, three-phase AC. Electric power generated by electric power generation facility 102 is transmitted to AC collector 103 and first AC conduits 128 with a current of I_{R-AC} and a voltage of V_{R-AC}. Approximately 85% to approximately 100% of I_{R-AC} is transmitted to rectifier LCC 118 through rectifier LCC transformer 122 to define I_{R-AC-LCC}. Moreover, approximately 0% to approximately 15% of I_{R-AC} is transmitted to rectifier CCC 120 through rectifier CCC conduit 142 to define I_{R-AC-CCC}.

Also, during normal power generation operation, I_{R-AC-LCC} is bifurcated approximately equally between the two AC conduits 150 to each HVDC rectifier device 146 through associated series capacitive devices 152. Switch devices 160 are open and thyristors 158 operate with firing angles α of less than 5°. The associated firing lag facilitates an associated lag between the electric current transmitted through thyristor 158 and the voltage induced by thyristor 158. Each associated series capacitive device 152 facilitates establishing such low values of firing angle α. This facilitates decreasing reactive power consumption by rectifier LCC 118. V_{R-DC-LCC} is induced.

Further, during normal power generation operation, rectifier CCC 120 induces voltage V_{R-DC-CCC}. V_{R-DC-CCC} and V_{R-DC-LCC} are summed in series to define V_{R-DC}. V_{R-DC-LCC} represents a much greater percentage of V_{R-DC} than does V_{R-DC-CCC}, i.e., approximately 85% or higher as compared to approximately 15% or lower, respectively. Series-coupled rectifier LCC 118 and rectifier CCC 120 both transmit all of I_{R-DC}.

Since V_{R-DC-LCC} represents a much greater percentage of V_{R-DC} than does V_{R-DC-CCC}, during normal power generation operation, rectifier LCC 118 effectively establishes the transmission voltage V_{R-DC}. In the exemplary embodiment, rectifier LCC 118 establishes the transmission voltage such that V_{R-DC-LCC} is approximately equal to a V_{I-DC-LCC} at inverter LCC 130. Rectifier LCC 118 consumes reactive power from power generation facility 102 at a substantially low value, i.e., less than 20% of the power rating of rectifier LCC 118. In addition, rectifier LCC 118 quickly decreases V_{R-DC} in the event of a DC fault or DC transient.

Also, since rectifier CCC 120 operates at a DC voltage approximately 15% or lower of V_{R-DC}, during normal power generation operation, rectifier CCC 120 varies V_{R-DC-CCC} and to regulate rectifier CCC 120 such that rectifier CCC 120 effectively regulates I_{R-DC} through substantially an entire range of operational values of current transmission though HVDC transmission system 100. As such, electric power orders, i.e., electric dispatch commands are implemented through a control system (not shown) coupled to rectifier CCC 120. Further, rectifier CCC 120 facilitates active filtering of AC current harmonics.

Further, during normal power generation operation, rectifier portion 108 rectifies the electric power from sinusoidal, three-phase AC power to DC power. The DC power is transmitted through HVDC transmission conduits 112 and 114 to inverter portion 110 that converts the DC power to three-phase, sinusoidal AC power with pre-determined voltages, currents, and frequencies for further transmission to electric power transmission and distribution grid 104.

More specifically, I_{R-DC} is transmitted to inverter portion 110 through HVDC transmission conduits 112 and 114 such that current I_{I-DC} is received at inverter LCC 130. Moreover, a voltage of V_{I-DC-LCC} is generated by inverter LCC 130, a voltage of V_{I-DC-CCC} is generated across inverter CCC 132, and V_{I-DC-LCC} and V_{I-DC-CCC} are summed to define V_{I-DC}.

Furthermore, I_{I-AC-LCC} is bifurcated into two substantially equal parts that are transmitted through HVDC inverter devices 186, associated series capacitive devices 192, AC conduits 190, and inverter LCC transformer 134 to generate AC current I_{I-AC-LCC} that is transmitted to second AC conduits 140. Current I_{R-AC-CCC} is generated by inverter CCC 132 and transmitted through inverter CCC conduit 182. I_{I-AC-LCC} and I_{I-AC-CCC} are summed to define I_{I-AC} that is transmitted through second AC conduits 140 that are operated at AC voltage V_{I-AC} as induced by grid 104. AC current I_{I-AC-LCC} is approximately 85% to 100% of I_{I-AC} and AC current I_{R-AC-CCC} is approximately 0% to 15% of I_{I-AC}.

Moreover, during normal power generation operation, inverter CCC 132 supplies reactive power to grid 104, i.e., approximately 10% of the reactive power rating of inverter portion 110, to control a grid power factor to unity or other values. In addition, inverter CCC 132 cooperates with rectifier CCC 120 to substantially control transmission of harmonic currents to grid 104. Specifically, those significant, i.e., dominant harmonic currents, e.g., 11^{th} and 13^{th} harmonics, that can have current values as high as approximately 10% of rated current, are significantly reduced while maintaining total harmonic distortion (THD) in the grid current, i.e., I_{I-AC} as transmitted to grid 104, below the maximum THD per grid standards. Therefore, CCCs 120 and 132 substantially obviate a need for large filtering devices and facilities. Moreover, for small grid-side or DC-side transients, CCCs 120 and 132 facilitate robust control of DC line current I_{R-DC} and I_{I-DC}.

In general, during steady state normal power generation operation, electric power flow from electric power generation facility 102 through system 100 to grid 104 is in the direction of the arrows associated with I_{R-DC} and I_{I-DC}. Under such circumstances, rectifier LCC 118 establishes a DC voltage approximately equal to the DC transmission voltage V_{R-DC}, rectifier CCC 120 controls generation and transmission of DC current, i.e., I_{R-DC}, inverter LCC 130 controls in a manner similar to rectifier LCC 118 by establishing a DC voltage approximately equal to the DC transmission voltage V_{R-DC}, and inverter CCC 132 is substantially dormant. As rectifier CCC 120 approaches its predetermined ratings, inverter CCC 132 begins to assume control of I_{R-DC}. Also, in the event of a DC fault within HVDC transmission system 100, rectifier LCC 118 shifts from rectification operation to inversion operation to facilitate continuity of power to facility 102.

However, in the exemplary embodiment, both rectifier portion 108 and inverter portion 110 are bidirectional. For example, for those periods when no electric power generators are in service within facility 102, electric power is transmitted from grid 104 through system 100 to facility 102 to power auxiliary equipment that may be used to facilitate a restart of a generator within facility 102 and to maintain the associated equipment operational in the interim prior to a restart. Based on the direction of power flow, either of rectifier CCC 120 or inverter CCC 132 controls the DC line current I_{R-DC} and I_{I-DC}.

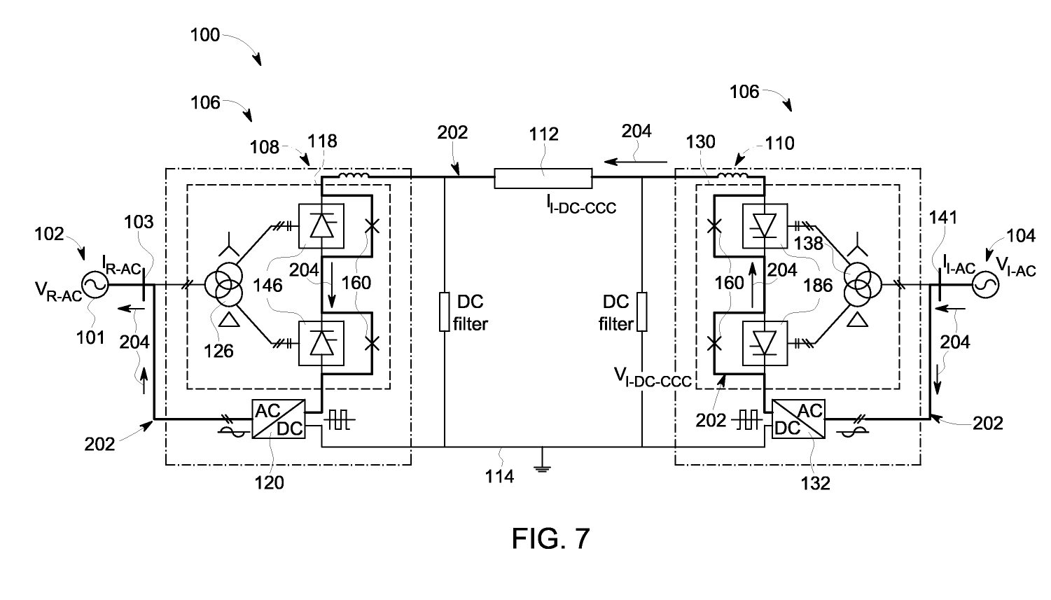

FIG. 7 is a schematic view of an exemplary black start configuration 200 that may be used with the HVDC transmission system 100. In the exemplary embodiment, a black start flow path 202 is defined from grid 104 through inverter CCC 132, switch devices 160 in inverter LCC 130, HVDC transmission conduit 112, switch devices 160 in rectifier LCC 118, and rectifier CCC 120 to AC collector 103 in electric power generation facility 102.

In the exemplary embodiment, both rectifier portion 108 and inverter portion 110 are bidirectional. For example, for those periods when no electric power generators are in service within facility 102, electric power is transmitted from grid 104 through system 100 to facility 102 to power auxiliary equipment that may be used to facilitate a restart of a generator within facility 102 and to maintain the associated equipment operational in the interim prior to a restart. Based on the direction of power flow, either of rectifier CCC 120 or inverter CCC 132 controls the DC line current I_{R-DC} and I^{I-DC}.

In black start operation, HVDC transmission system 100 starts with substantially most devices between grid 104 and facility 102 substantially deenergized. Transformers 134 and 122 are electrically isolated from grid 104 and facility 102, respectively. Switch devices 160 are closed, either locally or remotely, thereby defining a portion of path 202 that bypasses transformers 134 and 122, HVDC inverter devices 186, and HVDC rectifier devices 146, and directly coupling CCCs 132 and 120 with HVDC conduit 112.

Also, in black start operation, inverter CCC 132 charges rectifier CCC 120 through switch devices 160 and HVDC conduit 112 with DC power. Specifically, grid 104 provides a current of I_{I-AC} at a voltage of V_{I-AC} to inverter CCC 132. Inverter CCC 132 induces a voltage of V_{I-DC-CCC} and charges HVDC conduit 112 and rectifier CCC 120 to a predetermined DC voltage, i.e., V_{I-DC-CCC}. Once the voltage of V_{I-DC-CCC} is established, a current of I_{I-DC-CCC} is transmitted from inverter CCC 132, through HVDC conduit 112, to rectifier CCC 120. Rectifier CCC 120 establishes a three-phase AC voltage V_{R-AC} at AC collector 103 in a manner similar to that of a static synchronous compensation AC regulating device, i.e., STATCOM. Current I_{I-DC-CCC} is transmitted through HVDC transmission system 100 to arrive at facility 102 as I_{R-AC} as indicated by arrows 204. Once sufficient AC power has been restored to facility 102 to facilitate a base level of equipment operation, LCCs 118 and 130 may be restored to service such that a small firing angle α is established. Both CCCs 120 and 132 may be used to coordinate a restoration of DC power in HVDC transmission system 100.

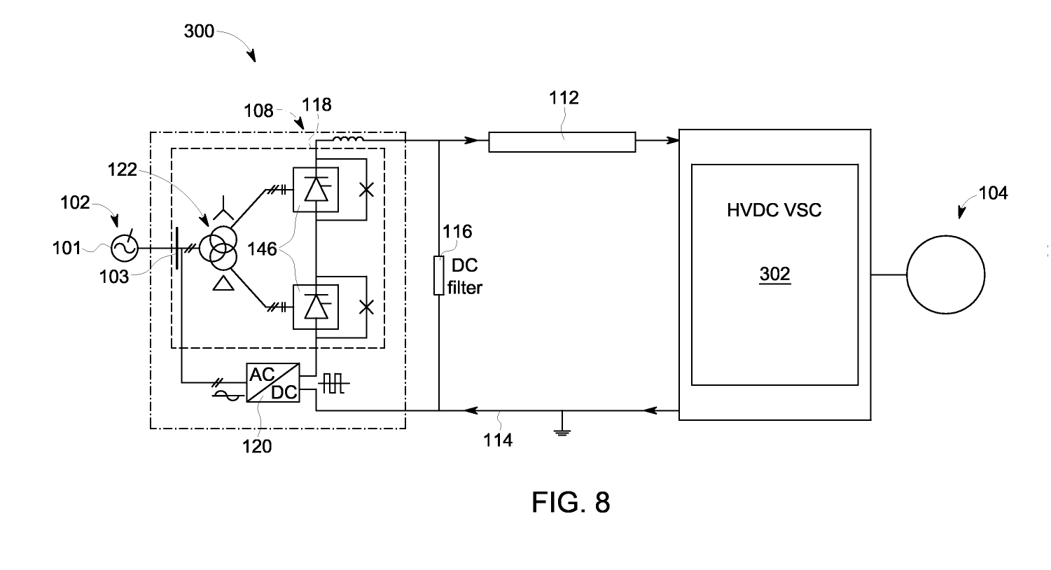

FIG. 8 is a schematic view of an exemplary alternative HVDC transmission system 300. In the exemplary embodiment, system 300 includes a HVDC voltage source converter (VSC) 302. VSC 302 may be any known VSC. For example, and without limitation, HVDC VSC 302 includes a plurality of three-phase bridges (not shown), each bridge having six branches (not shown). Each branch includes a semiconductor device (not shown), e.g., a thyristor device or an IGBT, with off-on characteristics, in parallel with an anti-paralleling diode (not shown). HVDC VSC 302 also includes a capacitor bank (not shown) that facilitates stiffening the voltage supply to VSC 302. VSC 302 further includes a plurality of filtering devices (not shown) to filter the harmonics generated by the cycling of the semiconductor devices. HVDC transmission system 300 also includes rectifier portion 108, including LCC 118 and CCC 120. In the exemplary embodiment, inverter portion 110 (shown in FIG. 1) is replaced with VSC 302. Alternatively, inverter portion 110 may be used and rectifier portion 108 may be replaced with VSC 302.

In operation, LCC 118 and CCC 120 operate as described above. However, VSC 302 does not have the features and capabilities to control DC fault current. However, VSC 302 can supply reactive power to a large extent and can perform harmonic current control in a manner similar to CCC 120. The scenario described above and shown in FIG. 8 is suitable for example for offshore generation where LCC rectifier 118 does not require a strong AC grid, but may require a black start capability, whereas the onshore VSC station 302 that connects the HVDC to grid 104 does require a strong grid voltage support such that VSC 302 may perform satisfactorily.

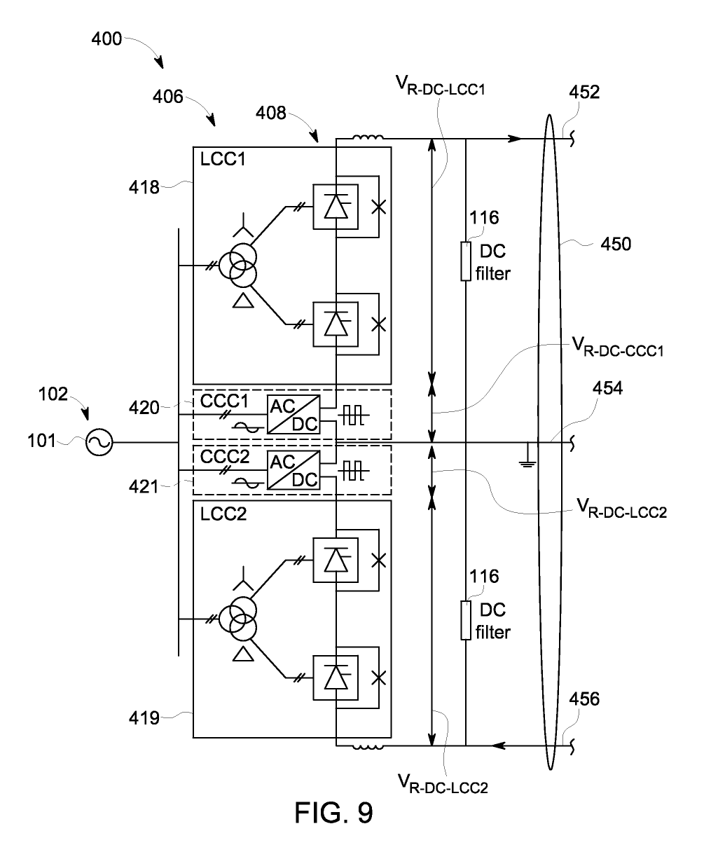

FIG. 9 is a schematic view of an exemplary alternative HVDC transmission system 400. System 400 is a bi-polar system that includes an alternative HVDC converter system 406 with an alternative rectifier portion 408 that includes a first rectifier LCC 418 and a first rectifier CCC 420 coupled in a symmetrical relationship with a second rectifier LCC 419 and a second rectifier CCC 421. System 400 also includes an alternative inverter portion (not shown) that is substantially similar in configuration to rectifier portion 408 as rectifier portion 108 and inverter portion 110 (both shown in FIG. 1) are substantially similar. In this alternative exemplary embodiment, rectifier portion 408 is coupled to the inverter portion through a bi-polar HVDC transmission conduit system 450 that includes a positive conduit 452, a neutral conduit 454, and a negative conduit 456.

In operation, system 400 provides an increased electric power transmission rating over that of system 100 (shown in FIG. 1) while facilitating a similar voltage insulation level. CCCs 420 and 421 are positioned between LCCs 418 and 419 to facilitate CCCs 420 and 421 operating at a relatively low DC potential as compared to LCCS 418 and 419 and conduits 452 and 456. Also, in the event of a failure of one of conduits 452 and 456, at least a portion of system 400 may be maintained in service. Such a condition includes system 400 operating at approximately 50% of rated with one related LCC/CCC pair, neutral conduit 454 in service, and one of conduits 452 and 456 in service.

The above-described hybrid HVDC transmission systems provide a cost-effective method for transmitting HVDC power. The embodiments described herein facilitate transmitting HVDC power between an AC facility and an AC grid, both remote from each other. Specifically, the devices, systems, and methods described herein facilitate enabling black start of a remote AC facility, e.g., an off-shore wind farm. Also, the devices, systems, and methods described herein facilitate decreasing reactive power requirements of associated converter systems while also providing for supplemental reactive power transmission features. Specifically, the devices, systems, and methods described herein include using a series capacitor in the LCC to decrease the firing angle of the associated thyristors, thereby facilitating operation of the associated inverter at very low values of commutation angles. The series capacitor also facilitates decreasing the rating of the associated CCC, reducing the chances of commutation failure of the thyristors in the event of either an AC-side or DC-side transient and/or fault, cooperating with the CCC to increase the commutation angle of the thyristors. Further, the devices, systems, and methods described herein facilitate significantly decreasing, and potentially eliminating, large and expensive switching AC filter systems, capacitor systems, and reactive power compensation devices, thereby facilitating decreasing a physical footprint of the associated system. Specifically, the devices, systems, and methods described herein compensate for, and substantially eliminate transmission of, dominant harmonics, e.g., the 11^{th} and 13^{th} harmonics. Moreover, the devices, systems, and methods described herein enhance dynamic power flow control and transient load responses. Specifically, the CCCs described herein, based on the direction of power flow, control the DC line current such that the CCCs regulate power flow, including providing robust control of the power flow such that faster responses to power flow transients are accommodated. Furthermore, the LCCs described herein quickly reduce the DC link voltage in the event of DC-side fault, Also, the rectifier and inverter portions described herein facilitate reducing converter transformer ratings and AC voltage stresses on the associated transformer bushings.

An exemplary technical effect of the methods, systems, and apparatus described herein includes at least one of: (a) enabling black start of a remote AC electric power generation facility, e.g., an off-shore wind farm; (b) decreasing reactive power requirements of associated converter systems; (c) providing for supplemental reactive power transmission features; (d) decreasing the firing angle of the associated thyristors, thereby (i) facilitating operation of the associated inverter at very low values of commutation angles; (ii) decreasing the rating of the associated CCC; (iii) reducing the chances of commutation failure of the thyristors in the event of either an AC-side or DC-side transient and/or fault; and (iv) cooperating with the CCC to increase the commutation angle of the thyristors; (e) significantly decreasing, and potentially eliminating, large and expensive switching AC filter systems, capacitor systems, and reactive power compensation devices, thereby decreasing a physical footprint of the associated HVDC transmission system; (f) compensating for, and substantially eliminating transmission of, dominant harmonics, e.g., the 11^{th} and 13^{th} harmonics; (g) enhancing dynamic power flow control and transient load responses through robust regulation of power flow by the CCCs; (h) using the LCCs described herein to quickly reduce the DC link voltage in the event of DC-side fault; and (i) reducing converter transformer ratings and AC voltage stresses on the associated transformer bushings.

Exemplary embodiments of HVDC transmission systems for coupling power generation facilities and the grid, and methods for operating the same, are described above in detail. The HVDC transmission systems, HVDC converter systems, and methods of operating such systems are not limited to the specific embodiments described herein, but rather, components of systems and/or steps of the methods may be utilized independently and separately from other components and/or steps described herein. For example, the methods may also be used in combination with other systems requiring HVDC transmission and methods, and are not limited to practice with only the HVDC transmission systems, HVDC converter systems, and methods as described herein. Rather, the exemplary embodiment can be implemented and utilized in connection with many other high power conversion applications that currently use only LCCs, e.g., and without limitation, multi-megawatt sized drive applications and back-to-back connections where black start may not be required.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A high voltage direct current (HVDC) converter system comprising:
at least one line commutated converter (LCC) configured to convert a plurality of alternating current (AC) voltages and currents to a regulated direct current (DC) voltage of one of positive and negative polarity and a DC current transmitted in only one direction; and
at least one current controlled converter (CCC) configured to convert a plurality of AC voltages and currents to a regulated DC voltage of one of positive and negative polarity and a DC current transmitted in one of two directions, wherein said at least one LCC and said at least one CCC are coupled in parallel to at least one AC conduit and are coupled in series to at least one DC conduit;
wherein said at least one LCC is coupled in parallel to at least one switch device and wherein said at least one CCC and said at least one switch device at least partially define a black start current transmission path.

2. The HVDC converter system in accordance with claim 1, wherein said at least one LCC and said at least one CCC define at least one of at least one HVDC rectifier device and at least one HVDC inverter device.

3. The HVDC converter system in accordance with claim 2, wherein said at least one DC conduit comprises a plurality of DC conduits, said at least one LCC comprises one of a plurality of said HVDC rectifier devices and a plurality of said HVDC inverter devices coupled in parallel to a transformer and coupled in series to said plurality of DC conduits.

4. The HVDC converter system in accordance with claim 3, wherein said at least one LCC further comprises at least one capacitive device coupled in series with each of said one of said plurality of said HVDC rectifier devices and said plurality of said HVDC inverter devices.

5. (canceled)

6. (canceled)

7. The HVDC converter system in accordance with claim 1 further comprising at least one voltage source converter (VSC), wherein said at least one LCC and said at least one CCC define one of at least one HVDC rectifier portion and at least one HVDC inverter portion coupled to said VSC.

8. The HVDC converter system in accordance with claim 1, wherein said at least one CCC comprises one of:
a single CCC coupled in series with one of a plurality of HVDC rectifier devices and a plurality of HVDC inverter devices, thereby defining a uni-polar configuration; and
a plurality of CCCs coupled in series with one of a plurality of HVDC rectifier devices and a plurality of HVDC inverter devices, thereby defining a bi-polar configuration.

9. A method of transmitting high voltage direct current (HVDC) electric power, said method comprising:
providing at least one line commutated converter (LCC) configured to convert a plurality of alternating current (AC) voltages and currents to a regulated direct current (DC) voltage of one of positive and negative polarity and a DC current transmitted in only one direction;
providing at least one current controlled converter (CCC) configured to convert a plurality of AC voltages and currents to a regulated DC voltage of one of positive and negative polarity and a DC current transmitted in one of two directions, wherein the at least one LCC and the at least one CCC are coupled in parallel to at least one AC conduit and are coupled in series to at least one DC conduit;
transmitting at least one of AC current and DC current to the at least one LCC and the at least one CCC;
defining a predetermined voltage differential across a HVDC transmission system with the at least one LCC;
controlling a value of current transmitted through the HVDC transmission system with the at least one CCC; and
closing at least one switch around the at least one LCC during a black start condition, thereby establishing a black start AC transmission path through at least a portion of the HVDC transmission system.

10. The method in accordance with claim 9 further comprising inducing a first DC voltage across the LCC comprising:
inducing a first DC voltage across a first LCC in a HVDC rectifier device; and
inducing a second voltage across a second LCC in a HVDC inverter device, wherein the second voltage has a value that is substantially similar to a value of the first voltage.

11. The method in accordance with claim 9, wherein defining a predetermined voltage differential across a HVDC transmission comprises:
inducing a first DC voltage across at least one LCC; and
inducing a second DC voltage across the at least one CCC, wherein the first DC voltage and the second DC voltage are summed to define the predetermined voltage differential across the HVDC transmission system.

12. The method in accordance with claim 9, wherein transmitting at least one of AC and DC to at least one CCC comprises controlling transmission of at least one of reactive power and harmonic currents.

13. (canceled)

14. The method in accordance with claim 9, wherein establishing a black start AC transmission path comprises:
establishing the black start AC transmission path through a CCC of an inverter device and a CCC of a rectifier device; and
inducing a three-phase voltage potential within at least a portion of the AC system.

15. A high voltage direct current (HVDC) transmission system comprising:
at least one alternating current (AC) conduit;
at least one direct current (DC) conduit;
a plurality of HVDC transmission conduits coupled to said at least one DC conduit; and
a HVDC converter system comprising:
at least one line commutated converter (LCC) configured to convert a plurality of alternating current (AC) voltages and currents to a regulated direct current (DC) voltage of one of positive and negative polarity and a DC current transmitted in only one direction; and
at least one current controlled converter (CCC) configured to convert a plurality of AC voltages and currents to a regulated DC voltage of one of positive and negative polarity and a DC current transmitted in one of two directions, wherein said at least one LCC and said at least one CCC are coupled in parallel to said at least one AC conduit and are coupled in series to said at least one DC conduit;
wherein said at least one LCC is coupled in parallel to at least one switch device and wherein said at least one CCC and said at least one switch device at least partially define a black start current transmission path.

16. The HVDC transmission system in accordance with claim 15, wherein said at least one LCC and said at least one CCC define at least one of at least one HVDC rectifier device and at least one HVDC inverter device.

17. The HVDC transmission system in accordance with claim 16 further comprising at least one transformer, wherein said at least one DC conduit comprises a plurality of DC conduits, said at least one LCC comprises one of a plurality of said HVDC rectifier devices and a plurality of said HVDC inverter devices coupled in parallel to a transformer and coupled in series to said plurality of DC conduits.

18. (canceled)

19. (canceled)

20. The HVDC transmission system in accordance with claim 15 further comprising at least one voltage source converter (VSC), wherein said at least one LCC and said at least one CCC define one of at least one HVDC rectifier portion and at least one HVDC inverter portion coupled to said VSC.
